(19) United States
(12) Patent Application Publication
(10) Pub. No.: US 2024/0401962 A1
(43) Pub. Date: Dec. 5, 2024

(54) STORAGE MEDIUM STORED WITH DATA GENERATION PROGRAM, METHOD, AND DEVICE

(71) Applicants: Fujitsu Limited, Kawasaki-shi (JP); KYUSHU UNIVERSITY, NATIONAL UNIVERSITY CORPORATION, Fukuoka-shi (JP)

(72) Inventors: Hiroaki YAMADA, Kawasaki (JP); Shohei YAMANE, Kawasaki (JP); Naoyuki KAMIYAMA, Fukuoka (JP)

(73) Assignees: Fujitsu Limited, Kawasaki-shi (JP); KYUSHU UNIVERSITY, NATIONAL UNIVERSITY CORPORATION, Fukuoka-shi (JP)

(21) Appl. No.: 18/732,046

(22) Filed: Jun. 3, 2024

(30) Foreign Application Priority Data
Jun. 5, 2023 (JP) 2023-092782

(51) Int. Cl. G01C 21/34; G06N 20/00; G08G 1/01

(52) U.S. Cl. CPC G01C 21/3492; G08G 1/0133; G06N 20/00

(57) ABSTRACT

Circuitry that executes a procedure including: from route information indicating a movement condition of moving bodies in a first period for each of a plurality of time points, extracting route information of moving bodies that started to move in a second period that is contained in, and shorter than, the first period; generating tally information in which a number of the moving bodies is tallied for each combination of a departure point and an arrival point in movements of the moving body contained in the route information, and generating information indicating a degree of congestion of traffic in the specific geographical range; and generating training data, in which the tally information is employed as input feature values and the information indicating the degree of congestion is employed as label information, as training data for a machine learning model for deriving a degree of congestion of traffic corresponding to tally information.

### CROSS-REFERENCE TO RELATED APPLICATION

This application is based upon and claims the benefit of priority of the prior Japanese Patent Application No. 2023-092782, filed on Jun. 5, 2023, the entire contents of which are incorporated herein by reference.

### FIELD

The embodiments discussed herein are related to a storage medium stored with a data generation program, a data generation method, and a data generation device.

### BACKGROUND

Hitherto technology has been available that uses traffic simulations to optimize schedules and the like for public transport. For example, in cases in which a running schedule is to be decided for a special bus service for when an event is to be held, there is a need to avoid generating or worsening congestion and so departure times are set for the special bus to match traffic conditions. In such cases traffic simulations are employed to search for an optimum schedule that will not cause congestion.

Considerable effort is needed to build a traffic simulation device. Moreover, there is also a high computational load during simulation execution. On the other hand, a surrogate model for simulation with high accuracy can be built by extracting traffic demands and traffic densities from probe data, and training a relationship between the two using a machine learning model such as a neural network. Because a surrogate model has a lower computational load, the application range for optimizing tasks using simulations can be expanded. For example, application may be made even to optimization of daily schedules.

As a technology related to traffic simulations using a surrogate model, there is a proposal for a machine learning device that estimates people flows and traffic flows efficiently. In such a device, a first parameter representing an environment and a second parameter representing an attribute of movement in the environment by plural respective moving bodies are acquired, and the plural moving bodies are then classified into plural groups based on the second parameter. Moreover in such a device, a third parameter is generated to indicate the number of the moving bodies classified into the plural respective groups, the first parameter and the third parameter are input to a machine learning model, and estimation information related to the movement in the environment of the plural moving bodies is generated.

### RELATED DOCUMENTS

### Related Patent Documents

### Japanese Patent Application Laid-Open (JP-A) No. 2022-131393

### SUMMARY

According to an aspect of the embodiments, a non-transitory recording medium storing a program that causes a computer to execute a data generation process including: from route information indicating a movement condition of plural respective moving bodies in a specific geographical range in a first period for each of plural time points, extracting route information of moving bodies that started to move in a second period that is contained in the first period and is shorter than the first period; based on the extracted route information, generating tally information in which a number of the moving bodies is tallied for each combination of a departure point and an arrival point in movements of the moving body contained in the route information, and generating information indicating a degree of congestion of traffic in the specific geographical range; and generating training data, in which the tally information is employed as input feature values and the information indicating the degree of congestion is employed as label information, as training data for a machine learning model for deriving a degree of congestion of traffic corresponding to tally information.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram to explain a traffic simulation.

FIG. 2 is a schematic diagram illustrating an example of a road network.

FIG. 3 is a diagram to explain a machine learning phase of a surrogate model.

FIG. 4 is a diagram to explain an optimization phase using a surrogate model.

FIG. 5 is a diagram to explain data augmentation of series data.

FIG. 6 is a diagram to explain issues arising when normal data augmentation is applied to series data.

FIG. 7 is a functional block diagram of a data generation device according to an exemplary embodiment.

FIG. 8 is a diagram illustrating an example of probe data and route information.

FIG. 9 is a diagram illustrating an example of time windows.

FIG. 10 is a diagram illustrating an example of a movement start time list.

FIG. 11 is a diagram illustrating an example of an ID list.

FIG. 12 is a diagram illustrating an example of route information extracted for each time window.

FIG. 13 is a diagram to explain generation of an OD matrix and traffic densities based on route information extracted for each time window.

FIG. 14 is a block diagram illustrating a schematic configuration of a computer that functions as a data generation device.

FIG. 15 is a flowchart illustrating an example of data generation processing.

### DESCRIPTION OF EMBODIMENTS

Description follows regarding an example of an exemplary embodiment according to technology disclosed herein, with reference to the drawings.

### Traffic Simulation and Surrogate Models: Outline and Issues

Prior to describing details of the exemplary embodiments, traffic simulations and surrogate models in general will first be described, together with some of the issues that arise therewith.

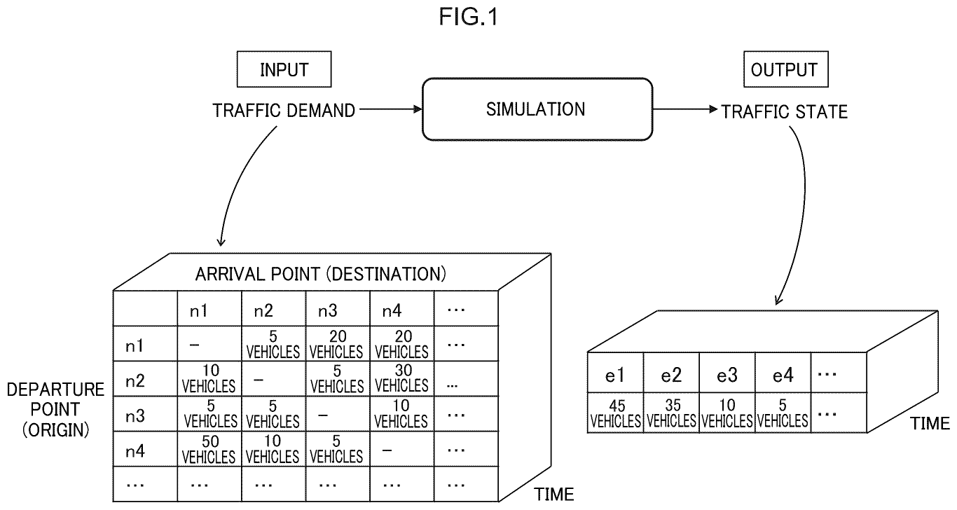

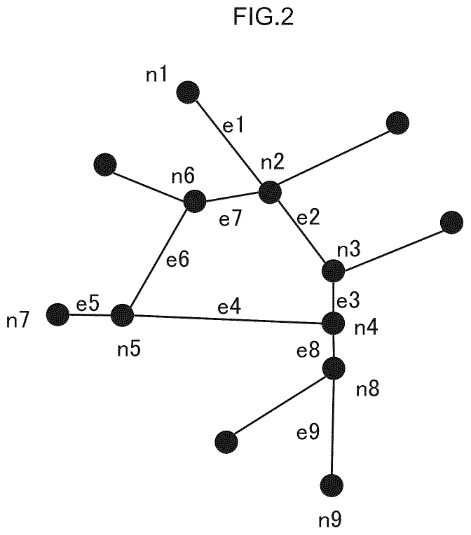

As illustrated in FIG. 1, a traffic simulation is input with traffic demand, and simulates and outputs traffic states corresponding to the traffic demands. For example, as illustrated in FIG. 2, a traffic simulation is performed using a road network expressed by plural nodes and links connecting between nodes. In the example of FIG. 2, nodes are represented by black circles and links are represented by connecting lines that connect between the nodes. Moreover, node identification numbers “ni (i=1, 2, . . . )” are written alongside the nodes, and link identification numbers “ej (j=1, 2, . . . )” are written alongside the links. In the following a node of identification number ni is indicated by “node ni”, and a link of identification number ej is indicated by “link ej”.

The traffic demand is, for example, represented by an OD matrix indicating a number of moving bodies (people, vehicles, and the like) that have moved between each ground point (node). The OD matrix is a matrix representation of nodes at departure points (origins) and nodes at arrival points (destinations), and is a representation in which the numbers of moving bodies that move from a departure point to an arrival point corresponding to each respective cell in the matrix are stored in that cell. Moreover, ODs by time band may be used to give a three-dimensional tensor as illustrated in FIG. 1 as traffic demand. Moreover, a traffic state is, for example, a traffic density expressed as a traffic volume for each link.

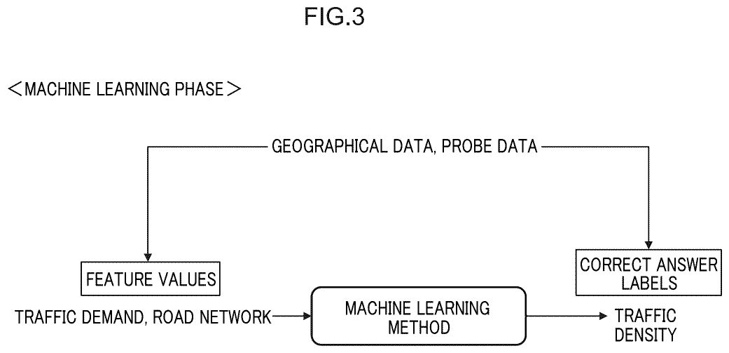

A machine learning model (surrogate model) for traffic simulation is a lightweight surrogate model to reproduce input/output relationships of traffic simulation such as illustrated in FIG. 1. As illustrated in FIG. 3, in a machine learning phase of a machine learning model, an information processing device takes geographical data and plural probe data, and extracts traffic demand and a road network serving as feature values therefrom, and also extracts traffic densities that serve as correct answer labels. The probe data is data recorded with location information (latitude and longitude or the like) for each moving body together with time stamps. The probe data is acquired using smartphones, various sensors and the like, and is collected over a network. Geographical data is data in which various geographical information, including road network information, are recorded.

The information processing device then inputs the extracted traffic demands and road network as feature values into the machine learning model configured by a neural network or the like, and acquires traffic densities inferred by the machine learning model. The information processing device then trains the machine learning model by updating the parameters of the machine learning model so as to minimize errors between the acquired traffic densities and the traffic densities that are the correct answer labels.

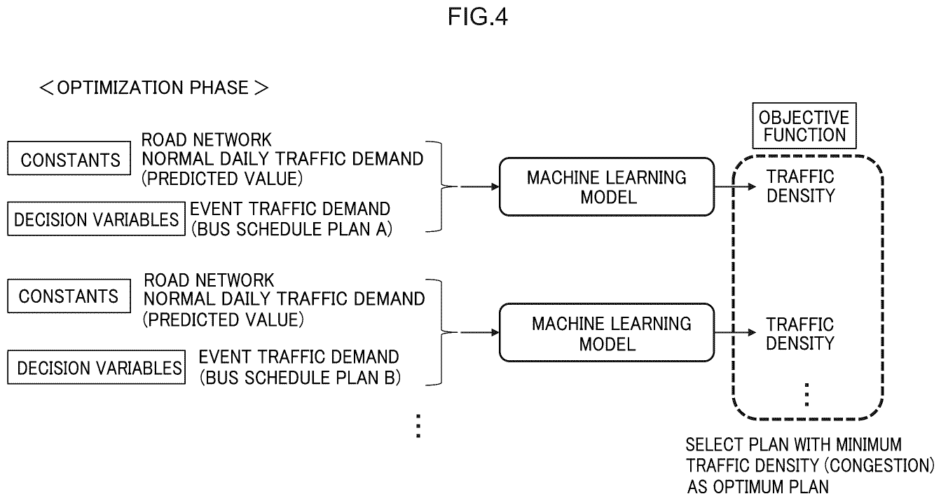

In the optimization phase using the trained machine learning model as illustrated in FIG. 4, the information processing device inputs the road network and the traffic demands into the machine learning model, and acquires the traffic densities that are the objective function. FIG. 4 illustrates an example of optimizing a running schedule for busses when an event is being held. In the example illustrated in FIG. 4, the information processing device inputs the machine learning model with the road network and predicted values of ordinary traffic demand as constants, and with event traffic demand for each bus running schedule plan as decision variables. Note that the road network may also be treated as a decision variable. The information processing device then compares the traffic densities obtained for each plan, and selects the plan with the minimum traffic density (congestion) for output as the optimum plan. Note that optimization may be executed by any suitable existing method, such as using a genetic algorithm or the like.

As stated above, data used to train a machine learning model (surrogate model) for traffic simulation is often difficult to acquire. Consideration is being given to generating training data by data augmentation methods because of the need for a lot of training data to build a high accuracy machine learning model.

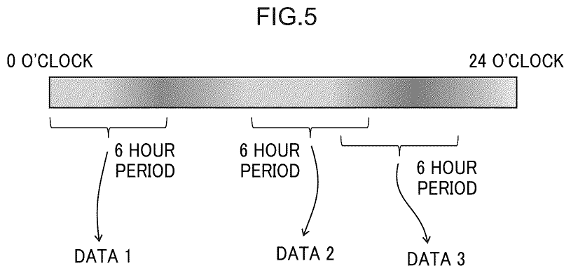

As a normal data augmentation method for series data, there is a method in which data is selected and extracted from series data using time windows. Such a method might conceivably be employed to generate feature values (traffic demands) and correct answer labels (traffic densities) based on data selected and extracted from data of traffic volumes of a first period, using a time window of a second period shorter than the first period. For example, as illustrated in FIG. 5, data might be selected and extracted with time windows of 6 hours from data of one day's worth (0:00 to 24:00) of traffic volumes. Plural sets of data can be extracted from one day's worth of traffic volume data by setting plural time windows of 6 hours inside the one day period. Note that FIG. 5 represents the traffic volume at each time slot by a darkness of shading.

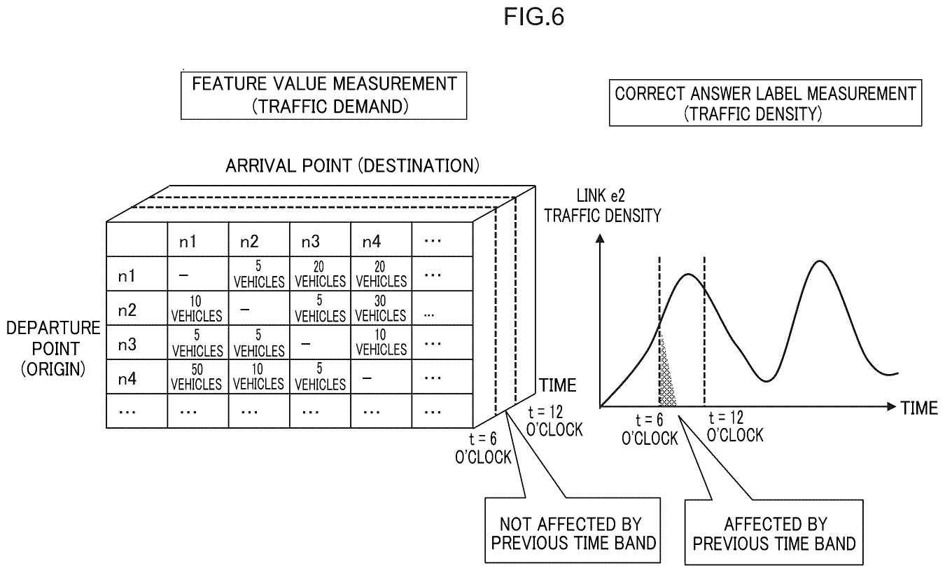

Sometimes an inconsistency arises between the feature values and correct answer labels when such a method is applied to feature values (traffic demands) and correct answer labels (traffic densities) employed to train a machine learning model. For example consider a case in which, as illustrated in FIG. 6, data is selected and extracted by a time window (t=6 o'clock to 12 o'clock in the example of FIG. 6) from an OD matrix, and also data regarding traffic densities is also selected and extracted by a similar time window. In such cases, the data for traffic densities of the selected and extracted portion is affected by the previous time band. The example of FIG. 6 illustrates, as a traffic density, the traffic density of link e2. For example, at the stage of t=6 o'clock, an accumulation of 100 vehicles occurs at link e2 due to a traffic jam, and this accumulation continues up to t=7 o'clock. In such cases an effect of an amount of the above accumulated portion (for example, the shaded portion in FIG. 6) remains in the data of the portion selected and extracted with this time window. On the other hand, the values in the OD matrix are number of vehicles at each time, and the data of the selected and extracted portion is not affected by the previous time band.

In cases in which training data with such an inconsistency between feature values and correct answer labels is employed to train a machine learning model, the inference accuracy of the machine learning model is unable to be raised. Thus in the present exemplary embodiment, when data is being selected and extracted with a time window, only data for moving bodies that start to move during a period from the start time to the end time of the time window are selected and extracted. The selected and extracted data are then employed to generate the traffic demands that are to be the feature values and the traffic densities that are to be the correct answer labels. This means that any effects prior to the start time of the time window are excluded from both the feature value side and the correct answer label side, and the feature values and the correct answer labels are consistent with each other.

### Data Generation Device According to Present Exemplary Embodiment

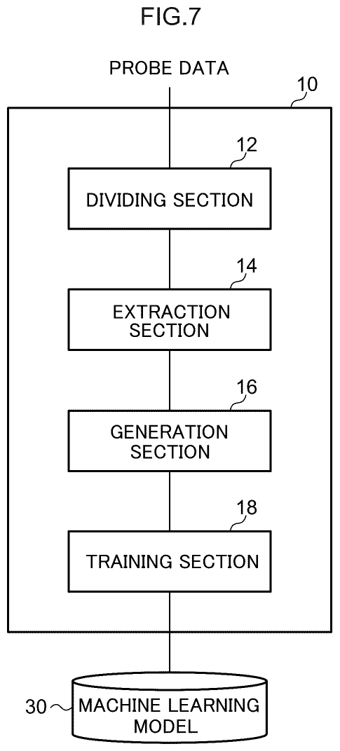

As illustrated in FIG. 7, a data generation device 10 according to the present exemplary embodiment includes a dividing section 12, an extraction section 14, a generation section 16, and a training section 18. Plural items of probe data are input to a data generation device 10. From this probe data, the data generation device 10 generates training data to be employed to train the machine learning model 30, and trains the machine learning model 30. The machine learning model 30 is, for example, configured by a neural network or the like.

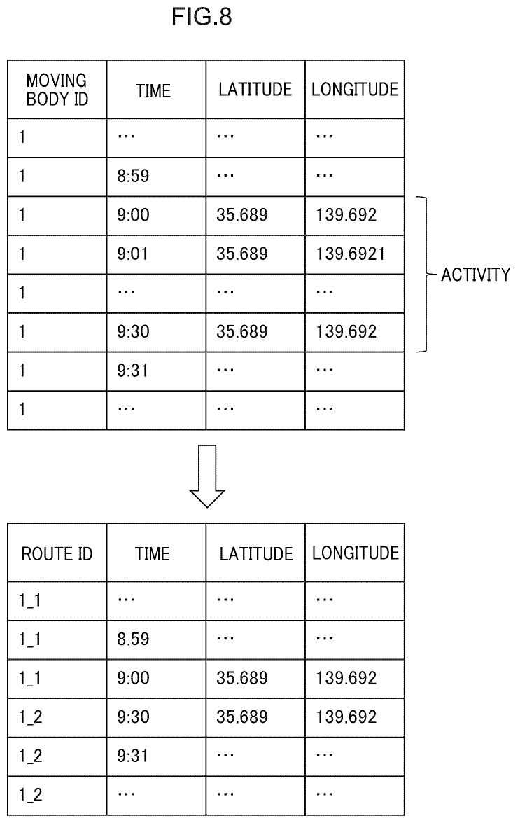

The dividing section 12 acquires the plural items of probe data input to the data generation device 10. The probe data is, for example, data indicating a movement condition of plural respective moving bodies as they were recorded over a single day. Namely, a history of one day of a given moving body is recorded in the probe data from the time point when power was switched ON to a recording device for recording probe data. This means that in the probe data of the plural respective moving bodies, the recording start time may, for example, be assumed to be concentrated in an early time band or the like. An example of raw data of the probe data is illustrated at the top of FIG. 8. The example of FIG. 8 represents probe data for a moving body having the moving body identification information (hereafter referred to as “moving body ID”) of 1, as expressed in a data format of {moving body ID, time, latitude, longitude}.

Although described in detail later, in the present exemplary embodiment data is selected and extracted by a time window with reference to a movement start time of the moving body. This means that were the method of the present exemplary embodiment to be applied to raw data of the probe data in which recording start times are concentrated in an early time band or the like as described above, then a state would arise in which hardly any data would be selected and extracted from any time windows set in the latter half portion of the first period.

In order to address this issue, the dividing section 12 divides the probe data of each of the moving bodies at a breakpoint of “activity”. Based on the times and the location information (latitude and longitude) indicated by the probe data, the dividing section 12 divides the probe data into before and after a portion where the location of the moving body indicates that the moving body has lingered for a certain period of time in a certain range. A state in which the location of a moving body has lingered for a certain period of time in a certain range is taken as there being some sort of activity (work, rest, or the like) occurring there, and dividing the probe data before and after when the activity was being performed is done in order to utilize data denoting movement as the route information.

For example, in the raw data of the probe data illustrated at the top of FIG. 8, the latitude and longitude lingered in a range of ±0.0001 for a 30 minute period of time from 9:00 to 9:30. The dividing section 12 takes this standstill portion as being when some sort of activity was being performed, and divides the probe data into data for up to and including 9:00, and data for 9:30 onwards. Thresholds of time and distance for determining a standstill are pre-set as values capable of excluding temporary standstills such as waiting at traffic lights or the like.

An example of the probe data after division is illustrated at the bottom of FIG. 8. The dividing section 12 treats each piece of data after division as route information, and appends identification information (hereafter referred to as a “route ID”) to each piece of route information. Namely, the route information resulting is information in which route IDs have been associated with a series of location information of a moving body for each of plural time points. In the example illustrated at the bottom of FIG. 8, the route ID is expressed in a format in which a branch number, indicating being an nth number of divided data, has been appended to the moving body ID. The dividing section 12 takes the route information for plural moving bodies, and collects these together as a parent set of data. When doing so the dividing section 12 may append a new route ID, such as a consecutive number or the like, to each piece of route information.

From the route information indicating a movement condition for plural respective moving bodies in a specific geographical range in the first period at each of plural time points, the extraction section 14 extracts route information of any moving bodies that started to move in a second period contained within the first period and shorter than the first period. The first period is a period (a single day, for example) of the parent set of data prior to selection and extraction with time windows. The second period is a period of a time window (for example 6 hours). The specific geographical range is an area indicated by a road network.

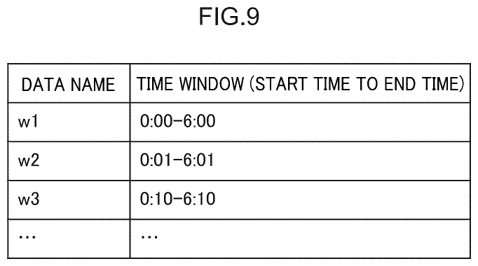

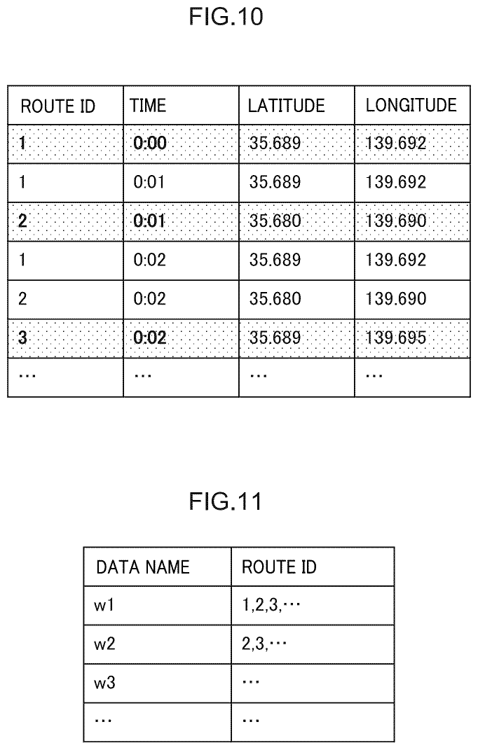

More specifically, as illustrated in FIG. 9, the extraction section 14 prepares ranges (start time to end time) of time windows to set in the first period associated with data names to append to data selected and extracted by the respective time windows. Moreover from the parent set data, as illustrated in FIG. 10, the extraction section 14 extracts the movement start times of each route information and creates a movement start time list in which the route IDs of the route information have been associated with the movement start times. The example of FIG. 10 represents parent set data in which respective items of the location information contained in the plural respective route information have been arranged in time sequence. In such cases, the extraction section 14 extracts the earliest time from out of the data appended with the same route ID as the movement start time associated with that route ID. In FIG. 10, the shaded data is data of the movement start times for respective route information.

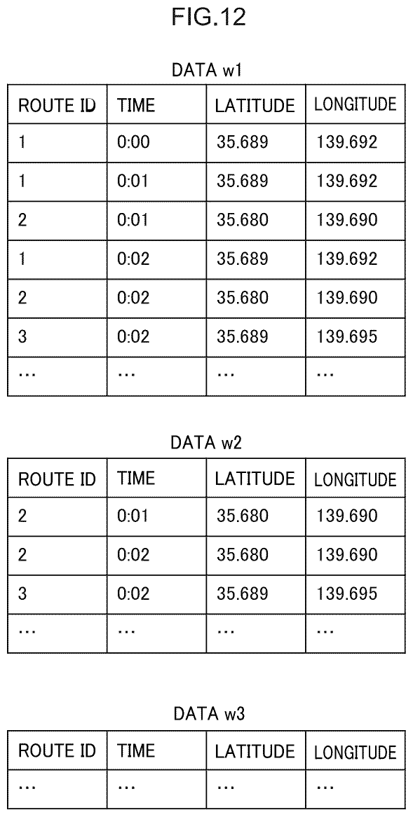

The extraction section 14 references the movement start time list, and creates an ID list of the route IDs of the route information containing movement start times in each time window, associated with data names corresponding to the time window. FIG. 11 illustrates an example of the ID list. The extraction section 14 references the ID list and selects and extracts data of the route IDs associated with each of the data names from the parent set data. FIG. 12 illustrates an example of selected and extracted data. The route information contains each of the selected and extracted items of data, with data having the same route ID arranged in time sequence. Namely, the selected and extracted data is route information extracted for each time window.

Based on the route information extracted by the extraction section 14 for each time window, the generation section 16 generates an OD matrix in which the number of moving bodies has been tallied for each combination of departure point and arrival point in the movements of moving bodies contained in the route information, and generates traffic densities of the specific geographical range.

More specifically, the generation section 16 associates the route information with a road network, compares location information (latitude and longitude) of moving bodies with location information of each link, and converts the route information that is a series of location information into route information that is a series of links where moving bodies are present at each time. Based on the route information that is a link series, the generation section 16 identifies nodes corresponding to the departure point and arrival point of each route information, and from each route information extracts an OD, which is a combination of the node corresponding to the departure point and the node corresponding to the arrival point. The generation section 16 then generates an OD matrix by counting the number of ODs that are the same and storing them in corresponding cells of the OD matrix. Based on the route information that is a link series, the generation section 16 generates, as traffic densities, link traffic flows representing the number of moving bodies present at each link and at each time point.

The generation section 16 generates training data, in which the generated OD matrix is input feature values and the generated traffic densities are correct answer labels, as training data for the machine learning model 30 for deriving a degree of congestion of traffic corresponding to traffic demand.

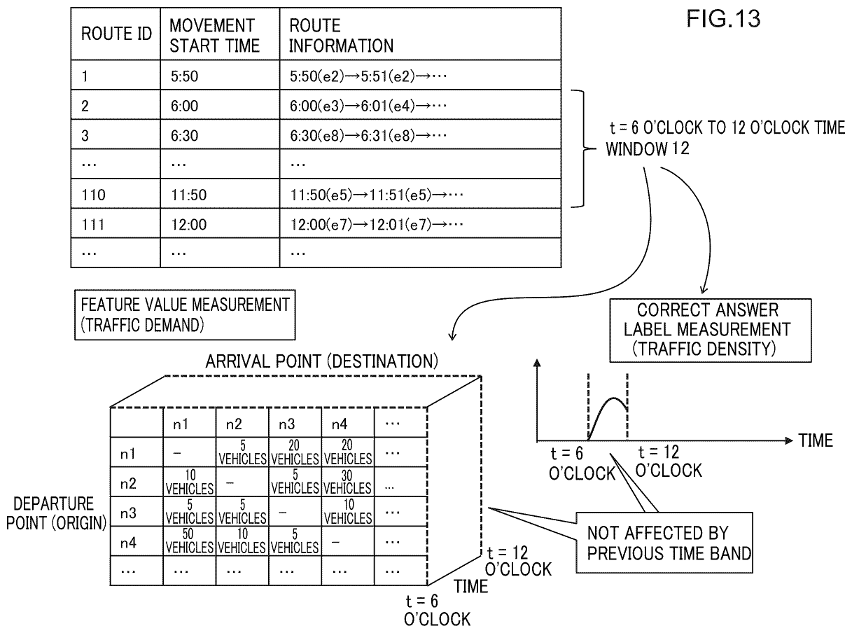

Thus as illustrated in FIG. 13, when selecting and extracting data with a time window in the present exemplary embodiment, any route information containing a movement start time in the time window is selected and extracted, and traffic demands and traffic densities are generated for this time window based on the selected and extracted route information. The effects of traffic conditions prior to the start time of the time window are accordingly also excluded on the correct answer label (traffic density) side, and the feature values and the correct answer labels are consistent with each other.

Note that to extract route information with reference to the movement start time, data onwards from the end time of the time window is also contained in the route information extracted, however for an OD matrix this is normally not an issue due to the OD normally being tallied by time of departure points. Moreover for the traffic densities, the end of the data may be cut off at the end time of the time window.

The training section 18 employs the training data generated by the generation section 16 to train the machine learning model 30. More specifically, the training section 18 inputs the generated OD matrix as feature values into the machine learning model 30, and acquires the traffic densities inferred by the machine learning model 30. The training section 18 then trains the machine learning model 30 by updating parameters of the machine learning model 30 such that errors between the acquired traffic densities and the traffic densities generated as correct answer labels are minimized.

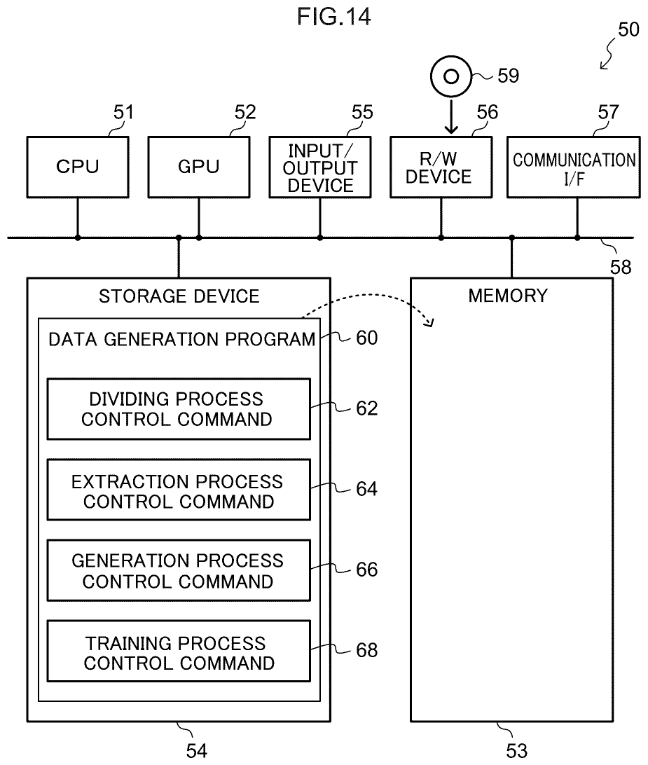

The data generation device 10 may, for example, be implemented by a computer 50 as illustrated in FIG. 14. The computer 50 includes a central processing unit (CPU) 51, a graphics processing unit (GPU) 52, memory 53 serving as a non-transitory storage area, and a non-volatile storage device 54. The computer 50 also includes an input/output device 55 such as an input device, display device, and the like, and a read/write R/W device 56 to control reading of data from a storage medium 59 and writing of data thereto. The computer 50 also includes a communication interface (I/F) 57 connected to a network such as the internet. The CPU 51, the GPU 52, the memory 53, the storage device 54, the input/output device 55, the R/W device 56, and the communication I/F 57 are connected to each other through a bus 58.

The storage device 54 is, for example, a hard disk drive (HDD), solid state drive (SSD), flash memory, or the like. A data generation program 60 that causes the computer 50 to function as the data generation device 10 is stored on the storage device 54 serving as a storage medium. The data generation program 60 includes a dividing process control command 62, an extraction process control command 64, a generation process control command 66, and a training process control command 68.

The CPU 51 reads the data generation program 60 from the storage device 54, expands the data generation program 60 in the memory 53, and sequentially executes the control commands contained in the data generation program 60. The CPU 51 operates as the dividing section 12 illustrated in FIG. 7 by executing the dividing process control command 62. The CPU 51 operates as the extraction section 14 illustrated in FIG. 7 by executing the extraction process control command 64. The CPU 51 operates as the generation section 16 illustrated in FIG. 7 by executing the generation process control command 66. The CPU 51 operates as the training section 18 illustrated in FIG. 7 by executing the training process control command 68. This means that the computer 50 that is executing the data generation program 60 functions as the data generation device 10. Note that the CPU 51 executing the program is hardware. Part of the program may be executed by the GPU 52.

Moreover, the functions implemented by the data generation program 60 may be implemented, for example, by a semiconductor integrated circuit, and more specifically by an application specific integrated circuit (ASIC), field programmable gate array (FPGA), or the like.

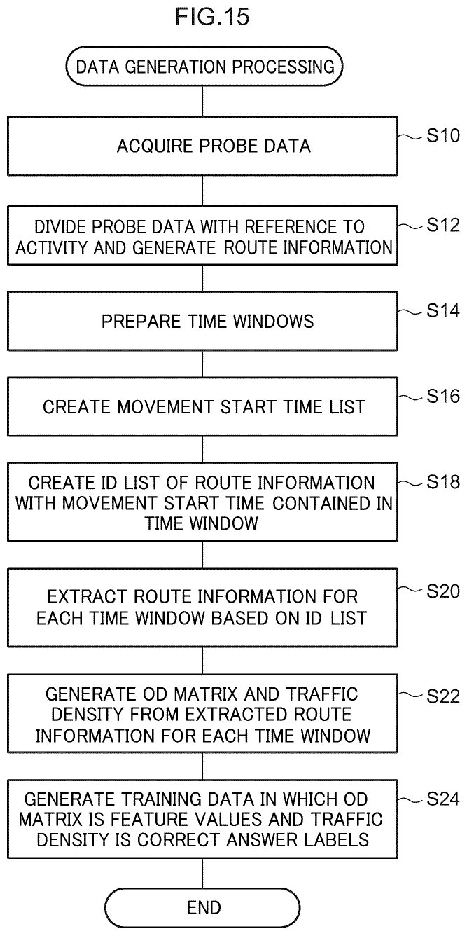

Next, description follows regarding operation of the data generation device 10 according to the present exemplary embodiment. When plural items of probe data are input to the data generation device 10, the data generation processing illustrated in FIG. 15 is executed in the data generation device 10. The data generation processing is an example of the data generation method of technology disclosed herein. Detailed explanation follows regarding the data generation processing.

At step S10, the dividing section 12 acquires the plural items of probe data that were input to the data generation device 10. Next, at step S12, based on the time and location information (latitude and longitude) indicated in the probe data, the dividing section 12 divides the probe data into being before or after a portion where the location of the moving body was indicated as lingering in a certain range for a certain period of time. The dividing section 12 appends a route ID to each part of the data after division, generates route information, and collects together route information for plural moving bodies as parent set data.

Next, at step S14, the extraction section 14 prepares ranges (start times to end times) of time windows to be set for the parent set data, associated with the data names to be appended to data selected and extracted by the respective time windows. Next, at step S16, the extraction section 14 extracts a movement start time for each item of the route information from the parent set data, and creates a movement start time list in which route IDs of route information have been associated with movement start times.

Next, at step S18, the extraction section 14 references the movement start time list, creates an ID list in which the route IDs of any route information containing a movement start time in each time window have been associated with the data name corresponding to the time window. Next, at step S20, the extraction section 14 references the ID list and, from the parent set data, selects and extracts data for route IDs associated with each data name. Namely, the extraction section 14 extracts route information for each of the time windows.

Next, at step S22, the generation section 16 generates an OD matrix and traffic densities based on the route information extracted at step S20 for each of the time windows. Next, at step S24, training data is generated in which the OD matrix is employed as feature values and the traffic densities are employed as correct answer labels, and then the data generation processing is ended.

The training section 18 then uses the training data generated by the data generation processing to train the machine learning model 30.

As described above, the data generation device according to the present exemplary embodiment extracts, from the route information indicating the movement condition of plural respective moving bodies in a specific geographical range in the first period for each of plural time points, the route information of any moving bodies that started to move in the second period shorter than the first period. Moreover, based on the extracted route information, the data generation device generates tally information, in which the number of moving bodies for each combination of departure point and arrival point is tallied for movements of the moving body contained in the route information, and generates information indicting the degree of congestion of traffic in the specific geographical range. The data generation device generates training data, in which the tally information is input feature values and the information indicating the degree of congestion is label information, as training data for the machine learning model for deriving a degree of congestion of traffic corresponding to the tally information. The thereby enables a lot of training data to be generated for building a machine learning model for high accuracy traffic simulation.

Note that although the above exemplary embodiment has been described for a data generation device including a training section, a configuration may be adopted in which the training section is configured by another computer, and the data generation device outputs the generated training data. In such cases the computer containing the training section employs the training data output from the data generation device to train the machine learning model.

Moreover, although in the above exemplary embodiment the data generation program is pre-stored (installed) on the storage device, there is no limitation thereto. The programs according to the technology disclosed herein may be provided in a format stored on a storage medium such as a CD-ROM, DVD-ROM, USB memory, or the like.

There is a need for training data encompassing a wide range of conditions to build a surrogate model for traffic simulation. However, data employed for training comes at a high cost, and is sometimes difficult to obtain due to not actually existing (measurement data for training is not obtainable in sufficient volume). This means that there is a need to generate a lot of training data for training a high accuracy surrogate model from a limited amount of data.

The technology disclosed herein enables a lot of training data to be generated for building a machine learning model for high accuracy traffic simulation.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory recording medium storing a program that is executable by a computer to perform a data generation process comprising:
from route information indicating a movement condition of a plurality of respective moving bodies in a specific geographical range in a first period for each of a plurality of time points, extracting route information of moving bodies that started to move in a second period that is contained in the first period and is shorter than the first period;
based on the extracted route information, generating tally information in which a number of the moving bodies is tallied for each combination of a departure point and an arrival point in movements of the moving body contained in the route information, and generating information indicating a degree of congestion of traffic in the specific geographical range; and
generating training data, in which the tally information is employed as input feature values and the information indicating the degree of congestion is employed as label information, as training data for a machine learning model for deriving a degree of congestion of traffic corresponding to tally information.

2. The non-transitory recording medium of claim 1, the data generation process further comprising:
generating the route information by dividing the movement conditions of the plurality of respective moving bodies recorded in the first period with reference to an activity of the moving body.

3. The non-transitory recording medium of claim 2, wherein:
a breakpoint of the activity of the moving body in the movement condition is a portion where a location of the moving body is indicated as lingering in a certain range for a certain period of time.

4. The non-transitory recording medium of claim 1, wherein:
the route information is information in which identification information of the route information has been associated with a series of location information of a moving body at each of the plurality of time points; and
a list is created in which movement start times of the route information have been associated with identification information of the route information, and for a plurality of second periods having different respective start times and end times, identification information of the route information for which the movement start time is contained in the second period is extracted from the list, and the route information associated with the identification information of the extracted route information is extracted.

5. The non-transitory recording medium of claim 1, the data generation process further comprising:
employing the generated training data to train the machine learning model.

6. A data generation method comprising:
from route information indicating a movement condition of a plurality of respective moving bodies in a specific geographical range in a first period for each of a plurality of time points, extracting route information of moving bodies that started to move in a second period that is contained in the first period and is shorter than the first period;
based on the extracted route information, generating tally information in which a number of the moving bodies is tallied for each combination of a departure point and an arrival point in movements of the moving body contained in the route information, and generating information indicating a degree of congestion of traffic in the specific geographical range; and
by a processor, generating training data, in which the tally information is employed as input feature values and the information indicating the degree of congestion is employed as label information, as training data for a machine learning model for deriving a degree of congestion of traffic corresponding to tally information.

7. The data generation method of claim 6, further comprising:
generating route information by dividing the movement conditions of the plurality of respective moving bodies recorded in the first period with reference to an activity of the moving body.

8. The data generation method of claim 7, wherein:
a breakpoint of the activity of the moving body in the movement condition is a portion where a location of the moving body is indicated as lingering in a certain range for a certain period of time.

9. The data generation method of claim 6, wherein:
the route information is information in which identification information of the route information has been associated with a series of location information of a moving body at each of the plurality of time points; and
a list is created in which movement start times of the route information have been associated with identification information of the route information, and for a plurality of second periods having different respective start times and end times, identification information of the route information for which the movement start time is contained in the second period is extracted from the list, and the route information associated with the identification information of the extracted route information is extracted.

10. The data generation method of claim 6, further comprising:
employing the generated training data to train the machine learning model.

11. A data generation device comprising:
a memory; and
a processor coupled to the memory, the processor being configured to execute processing, the processing including:
from route information indicating a movement condition of a plurality of respective moving bodies in a specific geographical range in a first period for each of a plurality of time points, extracting route information of moving bodies that started to move in a second period that is contained in the first period and is shorter than the first period;
based on the extracted route information, generating tally information in which a number of the moving bodies is tallied for each combination of a departure point and an arrival point in movements of the moving body contained in the route information, and generating information indicating a degree of congestion of traffic in the specific geographical range; and
generating training data, in which the tally information is employed as input feature values and the information indicating the degree of congestion is employed as label information, as training data for a machine learning model for deriving a degree of congestion of traffic corresponding to tally information.

12. The data generation device of claim 11, the processing further comprising:
generating the route information by dividing the movement conditions of the plurality of respective moving bodies recorded in the first period with reference to an activity of the moving body.

13. The data generation device of claim 12, wherein:
a breakpoint of the activity of the moving body in the movement condition is a portion where a location of the moving body is indicated as lingering in a certain range for a certain period of time.

14. The data generation device of claim 11, wherein:
the route information is information in which identification information of the route information has been associated with a series of location information of a moving body at each of the plurality of time points; and
a list is created in which movement start times of the route information have been associated with identification information of the route information, and for a plurality of second periods having different respective start times and end times, identification information of the route information for which the movement start time is contained in the second period is extracted from the list, and the route information associated with the identification information of the extracted route information is extracted.

15. The data generation device of claim 11, the processing further comprising:
employing the generated training data to train the machine learning model.
